(19) United States
(12) Patent Application Publication
(10) Pub. No.: US 2014/0032770 A1
(43) Pub. Date: Jan. 30, 2014

(54) DECLARATIVE SPECIFICATION OF COLLABORATION CLIENT FUNCTIONALITY

(71) Applicant: Nigel Pegg, San Francisco, CA (US)

(72) Inventor: Nigel Pegg, San Francisco, CA (US)

(73) Assignee: Adobe Systems Incorporated

(21) Appl. No.: 11/864,631

(22) Filed: Sep. 28, 2007

(51) Int. Cl. G06F 15/177

(52) U.S. Cl. 709/228

(57) ABSTRACT

Some embodiments may provide a method comprising accessing a first declarative specification element specifying a collaboration session context, accessing a second declarative specification element depending from the first declarative specification element. Some embodiments may further provide a method comprising generating, based on the first declarative specification element, first instructions to instantiate the collaboration session connection, generating, based on the second declarative specification element, second instructions, and generating sequencing instructions to prevent the second instructions from being executed until the collaboration session connection is instantiated.

### FIELD

Embodiments relate to computer-mediated collaboration systems and more specifically to methods and systems to enable declarative specification of collaboration client functionality.

### BACKGROUND

In recent years, computers have become widely used to support collaboration among people who are geographically distributed. Systems for collaboration enable multiple computers to log into a collaboration server and to exchange information with this server. The server may typically receive information from the various participants' computers and retransmit it to the computers.

For example, three computers may be logged into a collaboration server. Each computer may display on its screen a rendering of a shared drawing area or ‘whiteboard.’ Whenever a participant involved in the collaboration draws (e.g., via a mouse or other imputer device) some shapes or other graphic on that person's computer's screen, that persons computer may transmit information describing that graphic to the server, which in turn may transmit the information to the other computers so that the item drawn by the person on his or her own computer appears on the screens (or other output devices) of the other computers participating in the collaboration session. Similarly, other media such as audio, video, or text may be transmitted from one computer and retransmitted to the other computers. In this way, various people may be supported by the system in collaborative work or play.

In order for a participant's computer to connect to the server and enable the participation of that person in the collaborative experience, the participant's computer may first connect to the collaboration server and then determine what shared data is made available by the server. Having determined what shared data is available, the participant's computer can then begin receiving data transmitted from other computers in the collaboration session, and/or transmitting data for propagation to other computers in the collaboration session.

### BRIEF DESCRIPTION OF DRAWINGS

Some embodiments are illustrated by way of example and not limitation in the figures of the accompanying drawings in which:

FIG. 1 is a block diagram illustrating a system supporting computer-mediated collaboration, according to an example embodiment.

FIG. 2 is a diagrammatic illustration of a specification for declaratively specifying collaboration client functionality, according to an example embodiment.

FIG. 3 is a diagrammatic illustration of a process for parsing or otherwise processing a declarative specification that may include first and second declarative specification elements, according to an example embodiment.

FIG. 4 shows a flow chart of a process 400 for accessing specification elements and generating instructions based on those specification elements, according to an example embodiment.

FIG. 5 is a flow chart illustrating a process for instantiating a collaboration session context and creating widgets or other components within a collaboration client, according to an example embodiment.

FIG. 6 is a flow chart of a process for instantiating collaboration session context, according to an example embodiment.

FIG. 7 is a diagrammatic illustration of a graphical user interface that may be presented by a collaboration client during a collaboration session connection process, according to an example embodiment.

FIG. 8 is a diagrammatic illustration of a collaboration client graphical user interface as it may appear once a collaboration session is established and various widgets or other components provided by the collaboration client are created, have rendered their graphical user interfaces, and are successfully communicating with a collaboration server, according to an example embodiment.

FIG. 9 shows a diagrammatic representation of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced in other embodiments without these specific details.

Embodiments may, for example, be implemented as a stand-alone application (e.g., without any network capabilities), a client-server application or a peer-to-peer (or distributed) application. Embodiments may also, for example, be deployed by Software-as-a-Service (SaaS), Application Service Provider (ASP), or utility computing providers, in addition to being sold or licensed via traditional channels.

### INTRODUCTION

For the purposes of this specification, the term “electronic content” shall be taken to include any digital data that may be presented to a user (e.g., visually or audibly presented) and may include for example an electronic document, page-descriptive electronic content such as a page-descriptive electronic document, media stream, web page, hypertext document, declarative specification document, image, digital video or video recording, digital audio or audio recording, an animation, a markup language document, such as for example a hypertext markup language HTML or XML document, a fillable form or data describing application graphical user interface. A “content element” shall include any part or share of electronic content that is defined or discernable as a part or share. For example, a content element may be automatically discerned from a characteristic of the content element itself (e.g., a paragraph of an electronic document) or may be manually defined by a user (e.g., a user-selected collection of words in an electronic document, a user-selected portion of a digital image). Examples of content elements include portions of a page-descriptive document or other electronic document, such as, for example, pieces of electronic text or other material within the electronic document, portions of media streams such as sections of digital video or frames or sets of frames of digital video or digital audio, segments or frames of animations, electronic forms, form templates, form elements, form data, actuatable element specifications or instructions, and various elements presentable or accessible by users within electronic content, and the like. Content elements may include empty content, for example an electronic document may include a blank page; the content of the blank page, namely any data indicating its blankness, may in some embodiments be considered as a content element, namely an empty content element. Content elements may include format data such as, for example, position information describing the placement of other content element(s), or information specifying colors or fonts to be used in rendering other content element(s).

For the purposes of this specification, a content item may be “associated” with electronic content. Examples of such association include inclusion within a file or other data structure containing the electronic content, the presence of a direct or indirect reference to the content element within electronic content, or the presence of a data structure, file, or other mechanism by which a content element is associated with electronic content. The association of a content element with electronic content does not necessarily require that when the electronic content is presented (or otherwise made accessible to a user or as input to a machine), that the content element is, in the course of presentation or access, also presented or made accessible.

In considering the association between electronic content and an associated content element, the term “literally included” may be used. In this specification, electronic content may, for example, literally include a content item if the data structure that contains the data that largely describes the electronic content includes the data that largely describe the content element. In some embodiments, a content element may be associated with electronic content by reference, wherein the data that describes the content element is not directly contained within or integral with the data that describes the electronic content with which the element is associated.

For the purposes of this specification, the term “rendering” used as a verb includes presenting or making accessible electronic content or content elements to be perceived, viewed, or otherwise experienced by a user, or be made available for further processing, such as, for example, searching, digesting, printing, analyzing, distilling, or transforming by computational processes that may not include processing the intrinsic data structure describing the electronic content or content element. Whether a content element associated with an electronic content is included in the rendering of the electronic content may, by default, be determined by whether or not the content element is active.

For the purposes of this specification, the term “rendering” used as a noun includes human-perceivable representations of data that is within a machine and perception-specialized organizations of data defining such representations. For example, a rendering may include a pattern of human-perceivable matter or energy presented on an output device by a machine, as well as the organization of data within a machine specialized to define such patterns. For example, such organizations of data may include the electronic configuration of a memory used by a graphics display processor, or a file containing an audio segment suitable for playing via an audio system of a computer.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules may include hardware circuitry, optical components, single or multi-processor circuits, memory circuits, software program modules and objects, firmware, and combinations thereof, as appropriate for particular implementations of various embodiments. The term “module” includes an identifiable portion of code, data, or computational object to achieve a particular function, operation, processing, or procedure.

For the purposes of this specification, the term “portion” may be taken to include any part, component, subset, data structure, or other part included properly or improperly within an electronic content.

For the purposes of this specification, the term “event listener” may include software, hardware, programs, modules, or other computational artifacts adapted to or capable of detecting and/or recording one or more events, such as within the context of a graphical user interface, or events announced or indicated by a machine remote to a machine upon which an event handler is active.

For the purposes of this specification, the term “declarative” may include specifying that an affordance or rendering described by a particular data structure may have a particular characteristic without specifying how that characteristic is to be brought about in the rendering or development of the resulting data from the data object.

For the purposes of this specification, the term “electronic document” may be taken to include various types of data structures that represent printable artifacts in which an on-screen rendering of the data structure substantially corresponds to the printed version of the data structure.

For the purposes of this specification, a first textual element may be said to “semantically contain” a second textual element when, for example, a first textual element signifies the presence of a portion of electronic content, associated with the first textual element, where the second textual element includes content that is included in the portion of electronic content. For example, in an Extensible Markup Language (XML) representation, a tag name may semantically contain the tag's attributes and XML text between the start and end tags using the tag name.

Some embodiments relate to systems and methods for declarative specification of collaboration client functionality. For example, the programmer or other software developer may wish to develop a new type of client to permit multiple users to collaborate within a collaborative environment (which, in some embodiments, may be termed a “collaborative room”) while working remotely. In some embodiments, a central server (e.g., collaboration server) may handle the reception and transmission of data among the various client machines to facilitate collaborative communication among users. For example, suppose for purposes of example that one copy of collaboration client running on machine A and another copy is running on machine B. If both clients are to display a shared whiteboard, an operation of drawing on a shared whiteboard widget by a user of Machine A, a description of the drawing may be transmitted to the collaboration server and in turn to Machine B, where the drawing may be replicated on a display of machine B to provide a shared whiteboard experience among the user of Machine A and Machine B. Similar data transmission and redistribution from one client machine to other client machines in the collaboration may be carried out with respect to other types of affordances such as, for example, video streams captured by video cameras, shared files, and other components.

In some embodiments, to facilitate the participation of a user in a collaborative session with other users of other machines, a collaboration client (e.g., an application or other computational object to facilitate the client-side operations used to facilitate a collaboration session for a user) may carry out a number of operations. For example, the collaboration client may connect to the collaboration server and transmit to the collaboration server an indication of the collaboration session which the user wishes to join and authentication credentials such as, for example, a username and password. Once connected to the collaboration session, as provided by the collaboration server, the collaboration client (e.g., running on the user's local machine) may request the collaboration server to provide various details about the collaboration session. Such details or other data may include, for example, a list of current participants, video or audio streams, shared whiteboards, shared files and other attributes or resources of the collaboration sessions.

These attributes or resources may be used by a collaboration client to initialize various graphical user interface (GUI) affordances as rendered on the client machine. These attributes or resources may also be used by the collaboration client to receive data from the collaboration server relayed from other participants and to transmit the user's actions, images and the like to the collaboration server for re-transmission to the other participants' machines in the collaboration session.

In some embodiments, a collaboration client may include a number of components. For example, the collaboration client may include a module for contacting and communicating with a remote server. In addition, in some embodiments, the collaboration client may include one or more components corresponding to the various affordances displayed or rendered to the user. For example, the collaboration client may include a video player widget which may receive video stream from a collaboration server or alternatively transmit video stream provided by the user (e.g., captured by a local video camera) to a collaboration server while rendering the retrieved or transmitted video stream in a region of a GUI presented to the user by the collaboration client.

In some embodiments, a developer or other programmer may use a declarative specification such as in the form of an electronic document or other electronic content. The declarative specification may declaratively specify the collaboration session connection process. The declarative specification may also declaratively specify the various components that are able to transmit or receive collaborative data to or from the collaboration server and display such data on the GUI provided by the collaboration client. In those embodiments, a parser (or other processing tool) may accept the declarative specification provided by the user that declaratively specifies the connection and functionality of some or all of the collaboration client and produce instructions (e.g., source code and/or object code) to implement that functionality. In such embodiments, the collaboration client developer need not specify procedural source code or other imperative programming to carry out that functionality.

For the purposes of this specification, the term “collaboration session” may be taken to include any suitable temporal period in which two or more computers are in state of communication during which the actions of a user of one machine are rendered or presented to the user of the other machine in substantially real time.

For the purposes of this specification, the term “collaboration session connection” may be taken to include any suitable connection between two machines or computers that once established, may be used for, or facilitate a collaboration session implemented by the computers. For the purposes of this specification, the term “collaboration session context” may be taken to include aspects of a collaboration session (e.g., including the network connection to a collaboration server and session) that may be gathered and made available to a collaboration client, and that describe attributes and resources of the collaboration session used by components or widgets of a collaboration session to facilitate interaction between a collaboration client user and other collaboration participants via a collaboration server.

For the purposes of this specification, the term “declarative specification element” may be taken to include any content element, indication, or data item that declaratively specifies a procedure, process, module, component or other data processing artifact.

For the purposes of this specification, the term “instructions” may be taken to include any machine-readable instructions, whether executable directly as presented, or parseable or interpretable into machine-executable instructions. For purposes of this specification, “instructions” may include source and/or object code, software libraries, binaries, or other program objects. For the purposes of this specification, “executing instructions” may be taken to include both direct execution of instructions by a computer, as well as execution of instructions compiled, parsed, or interpreted into machine-executable code. For the purposes of this specification, the execution of instructions may be taken to include either executing instructions directly, or may be taken to include executing a series of machine-executable operations (e.g., object code) produced from or otherwise implementing the instructions that are not directly machine-executable (e.g., source code).

For the purposes of this specification, the term “instantiate” may be taken to include creation, initiation, and/or execution of an instance of data object or other computational or data processing element.

For the purposes of this specification, the term “sequencing instructions” may be taken to include instructions which may be used to control the sequence of execution of other instructions. For example, in some embodiments, sequencing instructions may be taken to include instructions that may determine control flow among modules or instructions, such as to control initiation or commencement of processing by instructions upon or according to satisfaction of some conditions.

For the purposes of this specification, the term “markup language tag” may be taken to include a tag or other hierarchical data element used within a markup language or a markup language electronic document.

For the purposes of this specification, the term “nested within” such as when applied to a second specification element nested within a first specification element, may be taken to include a configuration wherein the sequence of characters comprising the second specification element is completely surrounded by characters representing the first specification element.

For the purposes of this specification, the term “identification of a collaboration server” may be taken to include any suitable address (e.g., an Internet Protocol (IP) address), locator (e.g., uniform resource locator (URL)), location or other data by which a collaboration client may locate or contact a collaboration server.

For the purposes of this specification, the term “real-time collaboration container” may be taken to include a configuration of data within a client machine running a collaboration client with configuration of data describing a collaboration session with a collaboration server. In some embodiments, a real-time collaboration container may include context of the collaboration session within which the participants are meeting, such as, for example, its virtual location as represented by a uniform resource locator (URI), privacy restrictions of the session, and roles of the participants or users of the session.

For the purposes of this specification, the term “asynchronous operation” may be taken to include an operation whose execution results in the receipt of a response, in which the response may take an indeterminate amount of time to be received after the operation. For example, a communication between two machines, where the timing of the communication is subject to latency or is otherwise not under the control of either machine may be considered an asynchronous operation.

### Example Systems for Declarative Specification of Collaboration Client Functionality

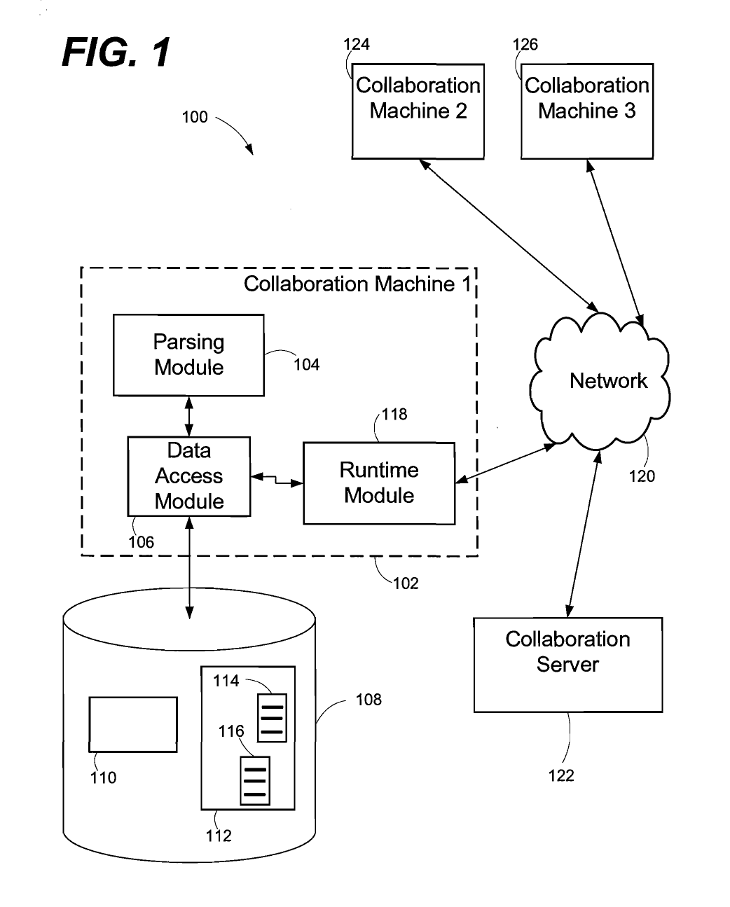

FIG. 1 is a block diagram illustrating a system 100, including modules and components supporting computer-mediated collaboration, according to an example embodiment.

The system 100 as shown in the example diagram of FIG. 1, three collaboration machines, collaboration machine 102, collaboration machine 124, and collaboration machine 126 are illustrated as being connected with one another and with a collaboration server 122 via a network 120. Within the collaboration machine 102 (as well as, e.g., other collaboration machines illustrated), a number of modules may be present. For example, a collaboration machine 102 may include a parsing module 104, a data access module 106, and a runtime module 118. In some embodiments, the runtime module 118 may be used to run a collaboration client such as, for example, by executing instructions in the form of source or object code. In some embodiments, the parsing module 104 may generate instructions based on declarative specification element, while a data access module 106 may be used to access declarative specification elements.

The system 100 may also include a data store 108 which may, in some embodiments, take the form of a hard disk, file system, flash memory, random access memory or other storage media or components. The data access module 106 may mediate access to the data store 108 for the parsing module 104 or runtime module 118. The data store 108 is illustrated as including declarative specification 110, which may include first declarative specification element and the second declarative specification element. In addition, the data store 108 may contain instructions 112 to be used to provide collaboration client functionality. Instructions 112 may include first instructions 114 and second instructions 116. The first instructions 114 may describe the instantiation of a collaboration session connection and construction of a collaboration session context. The instructions 112 may be stored in a single file, or one or more files. The instructions 112 may further includes sequencing instructions to prevent second instructions 116 from being executed until the collaboration session context is instantiated according to the first instructions 114.

It will be appreciated that the runtime module 118 may serve to connect the collaboration machine 102 to the collaboration server 122 through the network 120. The runtime module 118 may include various data objects or components for receiving and transmitting collaboration data to the server 122 and/or displaying renderings of collaboration data to a graphical user interface.

The operation of the runtime module 118 and the structure and characteristics of the declarative specification 110 and instructions 114 and 116 are described in more detail below.

### Example Declarative Specifications

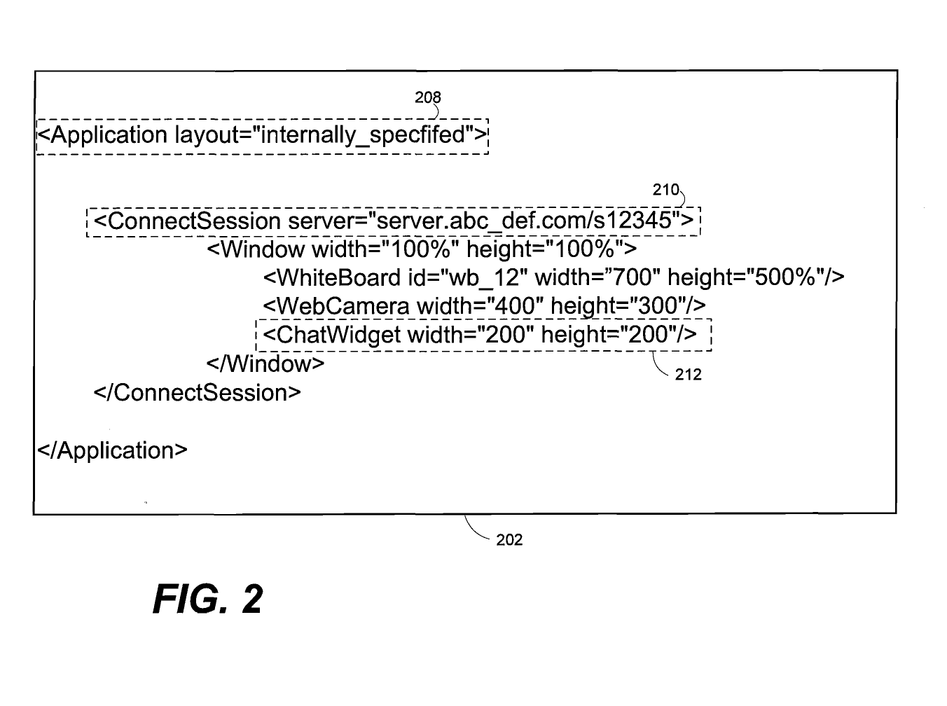

FIG. 2 is a diagrammatic illustration of a declarative specification 202 such as may be included within an electronic document for declaratively specifying collaboration client functionality, according to an example embodiment. The declarative specification 202 may be included in an electronic document or other file or files.

The declarative specification 202 may include a number of specification elements such as in the form of Extensible Markup Language (XML) or other markup language tags. The specification elements that may be used to declaratively (e.g., either partially or fully) specify a collaboration client. For example, in FIG. 2, an “Application” tag may serve to specify a collaboration client application as a whole. Such a top level “Application” tag is indicated in the example of FIG. 2 by the dashed rectangle 208. In some embodiments, a “layout” attribute may be included, such as to indicate whether the layout of various graphical user interface (GUI) components or widgets is to be automatically determined by the application or (such as in the case of the example of FIG. 2) internally specified by declarative specifications of the widgets themselves.

Semantically contained in, subordinate to, or in the example of FIG. 2 nested within the application tag 208, a “ConnectSession” tag (indicated by the rectangle 210) may be placed. The “ConnectSession” tag 210 may be used to declaratively specify or describe a connection session to a collaboration server such as, for example, the collaboration server 122 of FIG. 1. Returning to FIG. 2, This “ConnectSession” tag 210 may, in some embodiments, include a locator or other indication for the location or identification of the collaboration server such as, for example, in FIG. 2, “server.abcdef.com/s12345”.

In addition, the declarative specification 202 may include declarative specifications of one or more graphical user interface (GUI) components that may be used within a collaboration client to display shared data. For example, the declarative specification 202 includes a whiteboard declarative specification element, a web camera record/display declarative specification component, and a chat widget declarative specification element. For example, the chat widget declarative specification, indicated by the dashed rectangle 212, may include attributes specifying the characteristics of the chat widget to be displayed by the collaboration client such as, for example, a width or height in pixels or other display size units.

It will be appreciated that the chat widget specification element 212 and other declarative specification elements describing other widgets or components may be semantically contained by, nested within or otherwise subordinate either directly or indirectly to the connect session declarative specification element, in the example of FIG. 2, connect session tag 210. The arrangement of specification elements in such a nested configuration may permit a collaboration client programmer or developer to indicate that the components or widgets represented by the component declarative specification elements may be contained within the collaboration session declaratively specified by the connect session tag 210. It will be appreciated that in keeping with the declarative nature of the specification 202, the actual procedural or algorithmic specification of the processes by which a collaboration client may connect to a collaboration server, such as collaboration server 122, and instantiate or operate various widgets or components need not be specified within the declarative specification such as specification 202. The specification 202 may serve as an input for further processing such as, for example, a parsing module 104, which may access the declarative specification 202 via data access module 106.

In some embodiments, a declarative specification may include references to libraries, scripts, or other resources that may be used in parsing the specification elements or generating instruction based on the specification elements.

It will be appreciated that a wide variety of markup language syntax or construction may be used to declaratively specify widgets, components, collaboration session context instantiation, and other collaboration client operations and objects.

### Systems and Processes for Parsing Declarative Specifications and Declarative Specification Elements

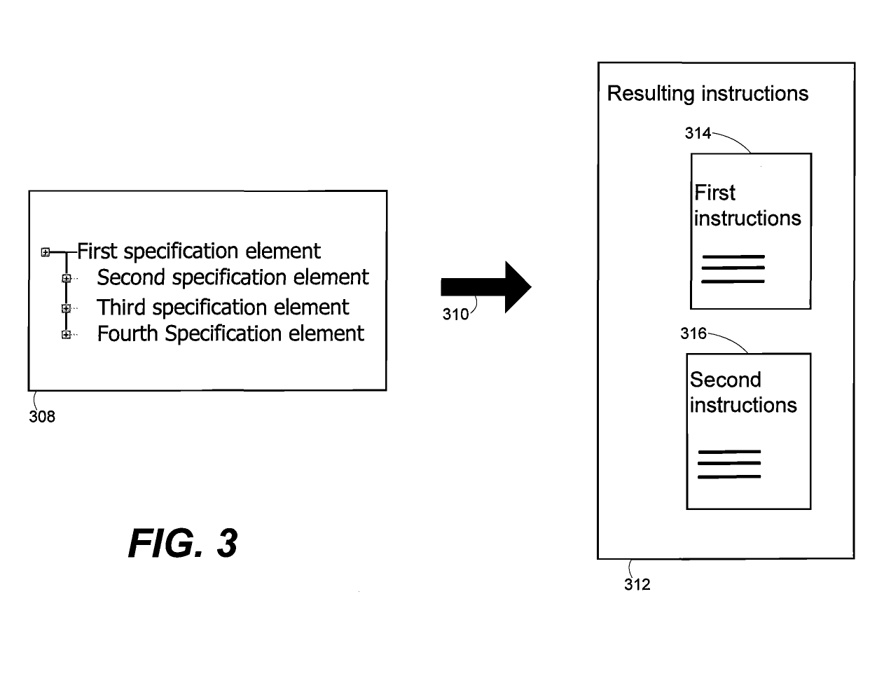

FIG. 3 is a diagrammatic illustration of a process for parsing or otherwise processing a declarative specification that may include first and second declarative specification elements, according to an example embodiment.

Once a programmer or other developer produces a declarative specification describing all or part of a collaboration client such as, for example, declarative specification 308 (e.g., declarative specification 202 of FIG. 2), a parser (such as, for example parsing module 104 or other markup language processing tool) may be applied to the declarative specification 308. As indicated in FIG. 3, the declarative specification may include a first specification element such as, for example, specifying the collaboration session as a whole, as well as subordinate or nested specification elements which may describe collaboration client user interface widgets or components.

In some embodiments, a parsing module 104 or other processing tool may carry out a parsing, interpreting or other code generation process as illustrated diagrammatically by the generation arrow 310. Output of this process may be a file 312 or in some embodiments multiple files including imperative or procedural code or instructions that may be executed, or in some embodiments further edited and compiled into a machine code that serve to implement the collaboration client functionality specified declaratively in a specification 308. In some embodiments, a parsing module 104 may make use of a data access module 106 running on the collaboration machine 102 to retrieve, from a data store 108, the declarative specification 308 (e.g., specification 110 of FIG. 1) and to output one or more instruction files 312 (e.g., files containing instructions 112 of FIG. 1). The resulting file 312 which may, in some embodiments, in the form of multiple files, may include (within a single file or among multiple files) first instructions 314 which may include instructions for instantiating a collaboration session context. The output of the parsing process may also include second instructions 316 which may serve as instructions for instantiating and/or operating a graphical user interface component or other component or widget made by the collaboration client specified by specification 308. In addition, the resulting file or files 312 may include sequencing instructions that may prevent the second instructions 316 from being executed until the collaboration session context is instantiated such as by the operation of the first instructions 314.

As noted above with respect to FIG. 2, the first declarative specification element and the second declarative specification element may include or be implemented by markup language tags. It will be further appreciated that the generation of the sequencing instructions to prevent the second instructions from being executed until a collaboration session context is instantiated by the first instructions, may be reflective of the subordinate or nested configuration of the second declarative specification element.

It will be appreciated that a wide variety of different components or widgets may be provided by a collaboration client or may be specified. Such components or widgets may be specified by declarative specification elements indicated diagrammatically within the declarative specification 308. For example, collaboration client components which may be specified by declarative element specification and created according to second instructions generated from a declarative specification element, may include a video player, a shared whiteboard, an audio player widget, a multi-user chat widget, a multi-user note-taking widget, a roster list (e.g. to indicate the users present in the collaboration session), a file sharing drop box widget, polling widget, a shared mapping component, a shared presentation component such as, for example, for presenting online slide presentations, shared document review widget or a shared musical instrument. It will be appreciated that these various widgets may make use of the collaboration session context during the operation of these components or widgets, such as by the execution of the instructions generated from the declarative specification of such components or widgets.

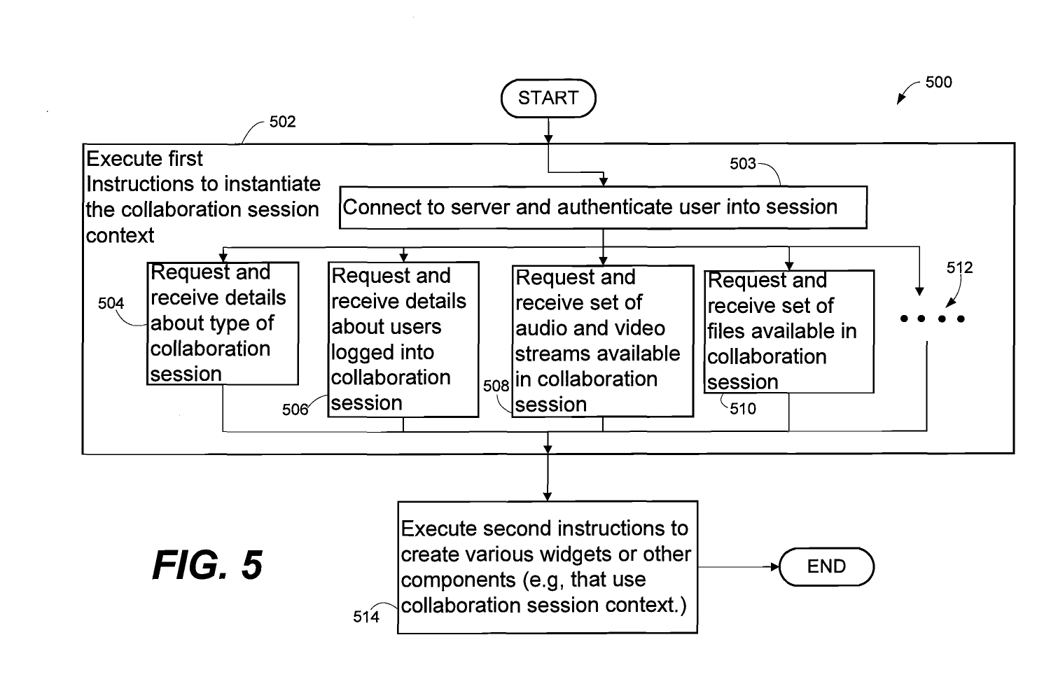

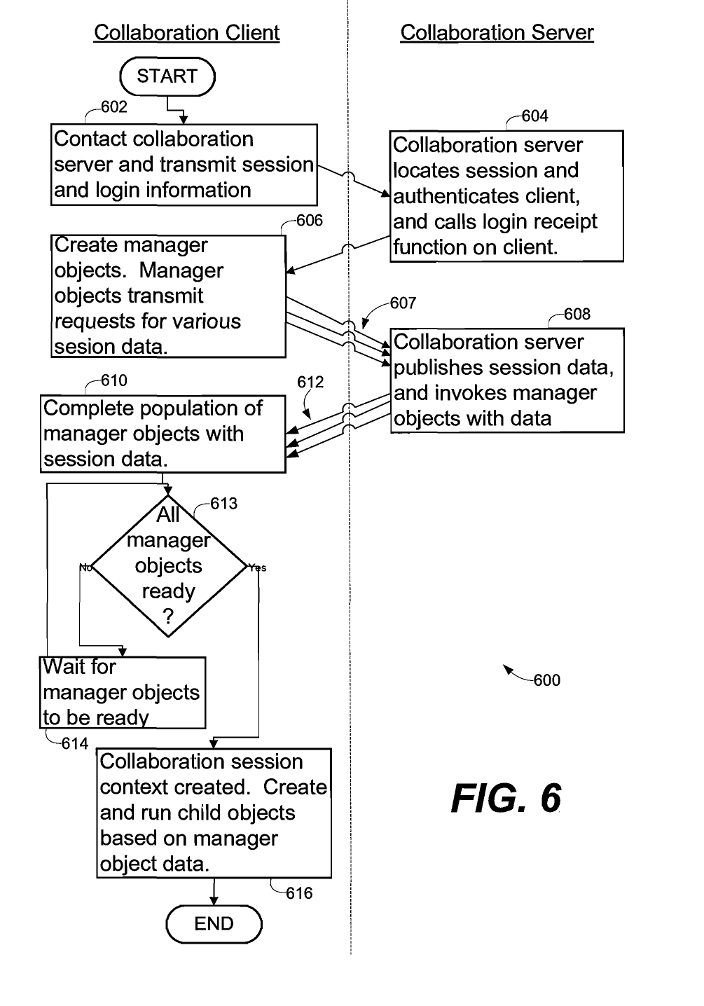

As noted with respect to declarative specification 202 of FIG. 2, the declarative specification element specifying a collaboration session context to be established, such as, for example the connect session tag 210 of FIG. 2 may include an identification of a collaboration server such as the collaboration server 122. The first instructions that may be generated by the parsing module 104 based on the declarative specification element specifying a collaboration session context, may include instructions operable to create a real time collaboration container. The first instructions may include synchronous operations as described below with respect to FIGS. 5 and 6.

### Processes for Accessing Declarative Specification Elements and Generating Instructions

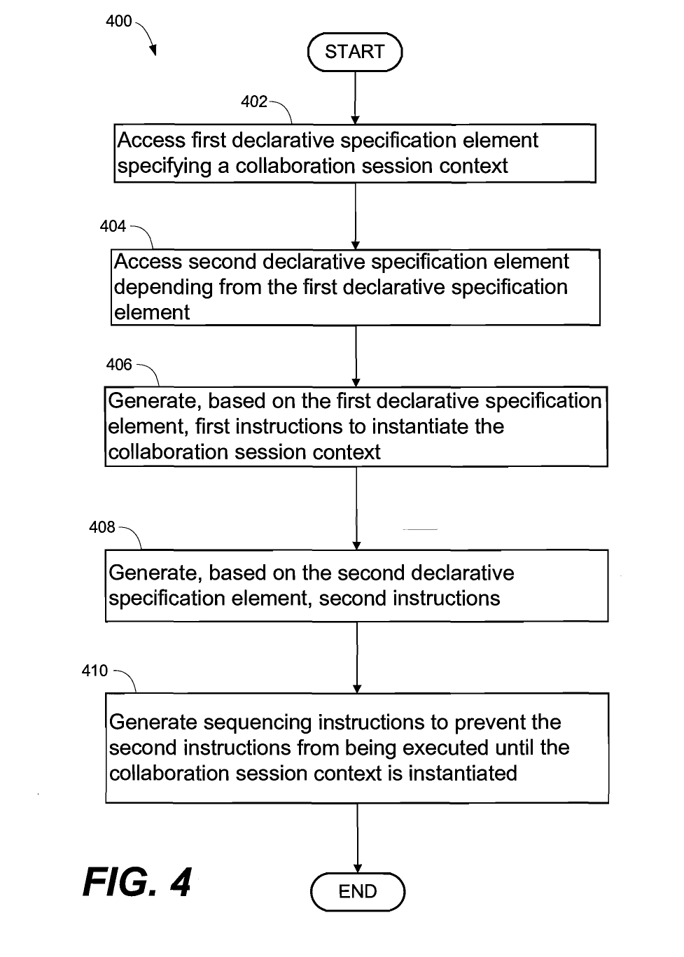

FIG. 4 shows a flow chart of a process 400 for accessing specification elements and generating instructions based on those specification elements, according to an example embodiment.

The process 400 may, in some embodiments, begin with the accessing of a first declarative specification element specifying collaboration session context at block 402. This accessing may be carried out, in some embodiments, by the data access module 106 operating to access the data store 108 such as in response to a request by the parsing module 104. Accessing the first declarative specification element may, in some embodiments, be carried in the context of accessing a declarative specification for a collaboration client such as, for example, the declarative specification 202. As described above, the first declarative specification element may, in some embodiments, take a form of an XML or other markup language tag such as, for example, the connect session tag 210 of FIG. 2.

At block 404, second declarative specification element that depends from the first declarative specification element may be accessed. This accessing may be carried out in response to a request by a parsing module 104 with the access being carried by the data access module 106. The second declarative specification element may depend from first specification element such as, for example, by nesting as a containment or other form of dependency in which the second declarative specification element depends from the first declarative specification element. It will be appreciated that, in some embodiments, such dependency or nesting may occur to multiple levels. In some embodiments, this second declarative specification element may specify a video player widget, a shared whiteboard widget or other types of graphical user interface and non-graphical user interface components within a collaboration client.

At block 406, first instructions to instantiate a collaboration session context may be generated based on first declarative specification. In some embodiments, this generation may be carried out by the parsing module with output, in some embodiments, stored into the data store 108 such as by the use of the data access module. In some embodiments, the first instructions may include a number of asynchronous operations by which a collaboration client may communicate with a collaboration server, for example, collaboration server 122. These operations, described by first instructions to instantiate a collaboration session context, may include operations for connecting to the server, authenticating a user login against the server, requesting details about the type of collaboration session such as, for example, private, open or other types, receiving responses from collaboration server 122, and accepting responses to these various operations. In some embodiments, the operations described by the instructions generated from or based on the first declarative specification element, may also include receiving a list of currently logged-in users to the collaboration session and receiving response requesting a set of audio or video sessions or streams and receiving response, requesting a set of published files displayed on that session and receiving response. It will be appreciated that, in some embodiments, first instructions generated based on the declarative specification element may be based on or depend on the types of components or widgets to be provided by the collaboration client.

At block 408, second instructions may be generated based on the second declarative specification element. Second instructions may, in some embodiments, be generated by the parsing module 104 stored into the data store 108 such as by use of the data access module 106. The second instructions, in some embodiments, code the instantiation, operation and/or user interaction with a collaboration server 122 and may make use of the collaboration session context instantiated by the operation of the first instructions (e.g., as generated in block 406).

At block 410, sequencing instructions may be generated to prevent second instructions from being executed until the collaboration session context is instantiated. In some embodiments, the operations at block 410 may be carried out by the parsing module 104 and stored into the data store 108 by the use of the data access module 106. In some embodiments, the sequencing instructions may be included within the first instructions so that the instantiation or creation of the data objects used in the operation of the collaboration client widgets is delayed until the completion of the collaboration section connection instantiation. In some other embodiments, the sequencing instructions may be generated as part of the second instructions to cause the execution of the second instructions to be delayed until the collaboration section connection is instantiated. In some other embodiments, the sequencing instructions may be generated into or stored in a file section or source code or other data structure separate from either the first instructions or the second instructions.

Example embodiments describing the operations coded by or implemented by the first and second instructions are described in further detail with respect to FIGS. 5 and 6.

In some embodiments, the generation of the first instructions, second instructions, and sequencing instructions may be carried out by a parser adopted to parse or otherwise process markup language files or other declarative specifications. In some other embodiments, an interpreter may be used or some other text or structured document processing tool. It will be appreciated that, in some embodiments, the instructions generated may be in the form of source code that, accordingly, may be further processed into a form executable by a machine.

### Example Processes for Execution of Generated Instructions by a Collaboration Machine

FIG. 5 is a flow chart illustrating a process 500 for instantiating a collaboration session context and creating widgets or other components within a collaboration client, according to an example embodiment.

FIG. 5 shows a process 500 which, in some embodiments, may be carried out by a collaboration client running on a collaboration machine 102. The operations illustrated in FIG. 5 may, in some embodiments, be carried by a runtime module 118 by executing instructions either directly via an interpreter or indirectly as compiled by a compiler or other tool, the instructions having been generated at block 406, 408 and 410 of FIG. 4.

At block 502, which is illustrated in FIG. 5 to encompass a number of other operations, the first instructions to instantiate a collaboration session context may be executed. These instructions may be generated based on the declarative specification element specifying a collaboration session context.

Within the processing illustrated in block 502, the collaboration client may connect to the server and authenticate the user to log into a collaboration session at block 503. It will be appreciated that this may be carried out, in some embodiments, by communication of the runtime module 118 with the collaboration server 122 via the network 120. Further processing, that may in some embodiments take place within or near that of block 503, may include request for and/or retrieval of various settings about the collaboration session or “room” such as for example bandwidth settings (e.g., upload and download speeds at which the room is optimized to run), public/private settings (e.g., whether guest users are allowed and whether guest users need permission from a host before connecting or entering the session), and/or user limit settings (e.g., a count of how many participants at maximum are allowed logged into a session or room). In some embodiments, the collaboration session instantiation instructions may broker the transmission of a guest login request and may await acceptance before allowing the collaboration component widgets (e.g., processing at block 514) to proceed for that guest login.

Once the processing at block 503 is completed, a number of further processing steps may be carried out according to the first instructions. For purposes of illustration, for example, operations are illustrated in blocks 504, 506, 508 and 510.

At block 504, the collaboration client may request and receive details about the type of the collaboration session that the collaboration client has logged into. At block 506, the collaboration client may request and receive details about the other users logged into the collaboration session such as a roster of currently logged-in users. At block 508, the collaboration client may request and receive a set of audio and video streams available in the collaboration session. Such requesting and receiving may, in some embodiments, be made when a video and/or audio widget or component is to be provided by the collaboration client. At block 510, the collaboration client may request and receive a set of files available in the collaboration session for shared viewing and/or editing.

In addition to and/or instead of operations illustrated in blocks 504, 506, 508 and 510, in some embodiments, different operations to receive collaboration session information may be specified by the first instructions. Accordingly, additional operations may be carried out as represented by the ellipses 512.

In some embodiments, the request and receive operations of blocks 504, 506, 508 and 510 may be carried out serially in the sense that execution of the first instructions as a whole are blocked until a response to request is received, such as from the collaboration server 122. In some embodiments, such as those suggested by the parallelism in the flow chart of FIG. 5, the requests for the various pieces of information from the collaboration server 122 may be carried out in an asynchronous, parallel or multi-threaded process. For example, in some embodiments, a data object that requests details about a type of collaboration session may be created and run on a separate thread of execution from the thread of execution running the main first instructions execution. The separate thread may then transmit a request about the type of collaboration session to the server and wait to receive a response, independently from the request for other information from the collaboration server 122.

Once each of the various request/receive processing illustrated in block 504, 506, 508 and 510, is successfully completed, the collaboration client may determine that the collaboration session context has become instantiated. At this point, sequencing instructions may permit the execution of second instructions to create the various widgets or components that use or depend upon the collaboration session context. Thereupon, the collaboration client may execute the second instructions to create the various widgets or other components that may, for example, make use of the collaboration session context. The execution of the second instructions is illustrated in FIG. 5 at block 514. Once the operations at block 514 have been carried out, further collaboration and transmission of data to and from the collaboration server by the various widgets or other components within the collaboration client may be carried out to facilitate the collaboration session among users. It will be appreciated that sequencing instructions, such as the sequencing instructions generated at block 410 (although not shown in FIG. 5) may be used to prevent the second instructions from being executed, such as at block 514, until the collaboration session context is instantiated. Such instantiation may, in some embodiments, include the determination by a thread of control associated with the first instructions that the various request received operations illustrated at 504 to 512 have all successfully completed.

FIG. 6 is a flow chart of a process 600 for instantiating collaboration session context, for example, by the execution of instructions based on the first declarative specification element specifying a collaboration session context, according to an example embodiment.

FIG. 6 illustrates an example of the interaction between a collaboration client, which may be running on a collaboration machine 102, and a collaboration server such as, for example, collaboration server 122. The operations illustrated on the collaboration client-side of FIG. 6 may, in some embodiments, be carried out by the collaboration client by executing the instructions generated based on the declarative specification element (e.g., connect session tag 210 of FIG. 2) specifying the collaboration session context. At block 602, the collaboration client may contact the collaboration server and transmit session and login information such as, for example, an indication of the collaboration session that the user wishes to log in to as well as user credential such as, for example, a username and/or password. The collaboration client main thread may then keep or otherwise wait for a response from the collaboration server. In some embodiments, the instructions being executed by the collaboration client to establish the collaboration session context may include a function callable by remote procedure call by the collaboration server.

At block 604, having received the session and login information from the collaboration client, the collaboration server may locate the session or authenticate the client. In response, the successful session location and authentication, a collaboration server may call, in some embodiments, a login receipt function on the client such as, for example, by remote procedure call. Once this remote procedure call has been received by the collaboration client, processing may continue at block 606.

In some embodiments, at block 606, one or more manager objects may be created within the collaboration client. These manager objects may execute on a separate thread of control from the main collaboration section connection thread, in some embodiments, in an asynchronous manner. These manager objects may include, in some embodiments, a remote procedure callable function callable by the collaboration server. In some embodiments, the manager objects may include event listeners to detect the transmission of data from the collaboration server. In addition, in some embodiments, the manager objects may include a flag indicating whether the manager object has received its requested data from the collaboration server.

In response to the asynchronous communications from the various manager objects for various session data, the collaboration server at block 608 may publish the session data and invoke the manager objects with that data such as, for example, via a remote procedure call (RPC) or via an event listening mechanism. The multi-threaded or parallel nature of the requests and responses by a publish and subscribe mechanism of data between the collaboration server and manager objects are illustrated by the multiple control flow lines 607 and 612.

At block 610, the various manager objects may asynchronously be populated with the session data according to their requests and thus may be considered to be completely constructed. Once each manager object is completely constructed, it may set its ‘ready’ flag to true and its associated thread may terminate.

Meanwhile, the main execution thread of the collaboration session context processing may continue to decision box 613. At decision box 613, a determination may need to be made whether all of the manager objects are completely constructed and populated with session data. If they are not all completely constructed, processing may continue at block 614 to prevent the second instructions (e.g., instructions for creating and/or operating widgets or other components within the collaboration client) from being executed. On the other hand, if all the manager objects are ready at decision box 613, processing may continue to block 616.

At block 616, the collaboration session may be determined to have been created and, in some embodiments, the collaboration client may then create and run child objects. Such child objects, for example, may be objects representing collaboration components specified, for example, as element specifications and taken as children in the sense of being nested or otherwise subordinate to the connection session element specification in the declarative specification of the collaboration client. In some embodiments, these various child widgets or other components in the collaboration client may be asynchronously run on separate child threads (e.g., in a multithreading arrangement) of the collaboration session context instantiation thread.

In some embodiments, the various pieces of session information and session resources obtained by the manager objects such as, for example, video streams, may be stored in a location accessible to the various objects implementing the widgets or other components.

In some embodiments, the manager objects, such as those created in block 606, may be stored in a dictionary, queue, or other data structure, which may then be processed or scanned, such as at decision box 613, to determine whether the manager objects are completely constructed, for example, are created and successfully received their associated session data from the collaboration server.

In some embodiments, the manager objects may be responsible for gathering data describing the collaboration session context. Such context-describing data may include files, users logged into the session, data streams available within the session, collaboration session (e.g., “room”) settings, and the like. Accordingly, the collaboration session context by be considered created and fully ready when all the manager objects finish receiving the context data for the collaboration session.

### Example Graphical User Interfaces for Collaboration Session Clients

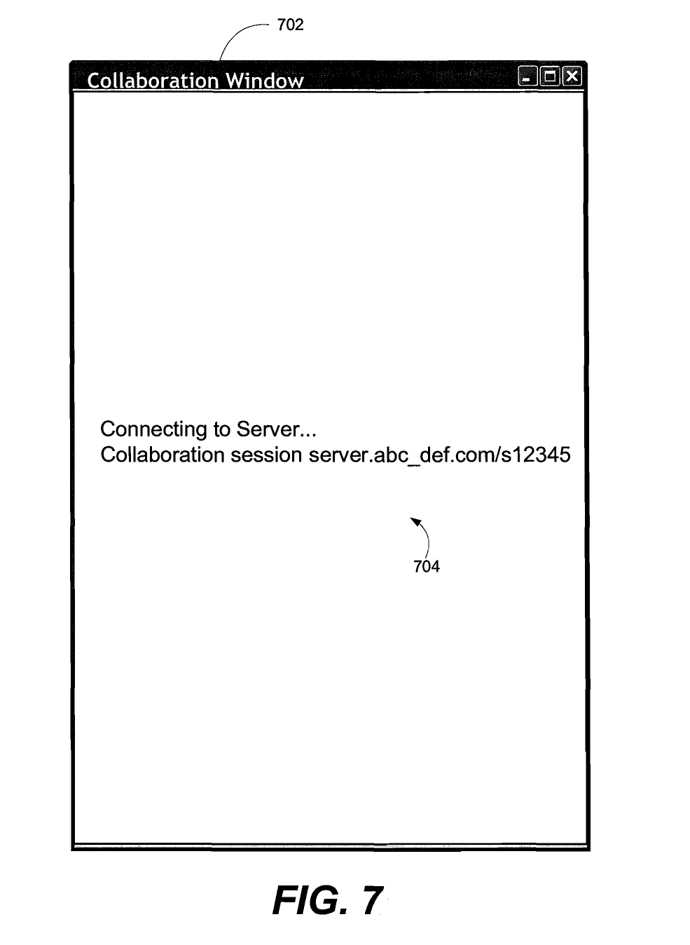

FIG. 7 is a diagrammatic illustration of a graphical user interface that may be presented by a collaboration client during the collaboration session connection process, according to an example embodiment.

In FIG. 7, a collaboration client user interface window 702 is illustrated. This collaboration window may be presented to a user by a collaboration client, which may be running on a collaboration machine 102. In the state illustrated in FIG. 7, the collaboration client may have just received a selection of a username and password or other credentials and is attempting to connect to a collaboration server 122. The status of the connection process may be indicated by legend 704 to indicate to the user that the connection to the server and an identification of the collaboration session server to which the connection attempt is being made.

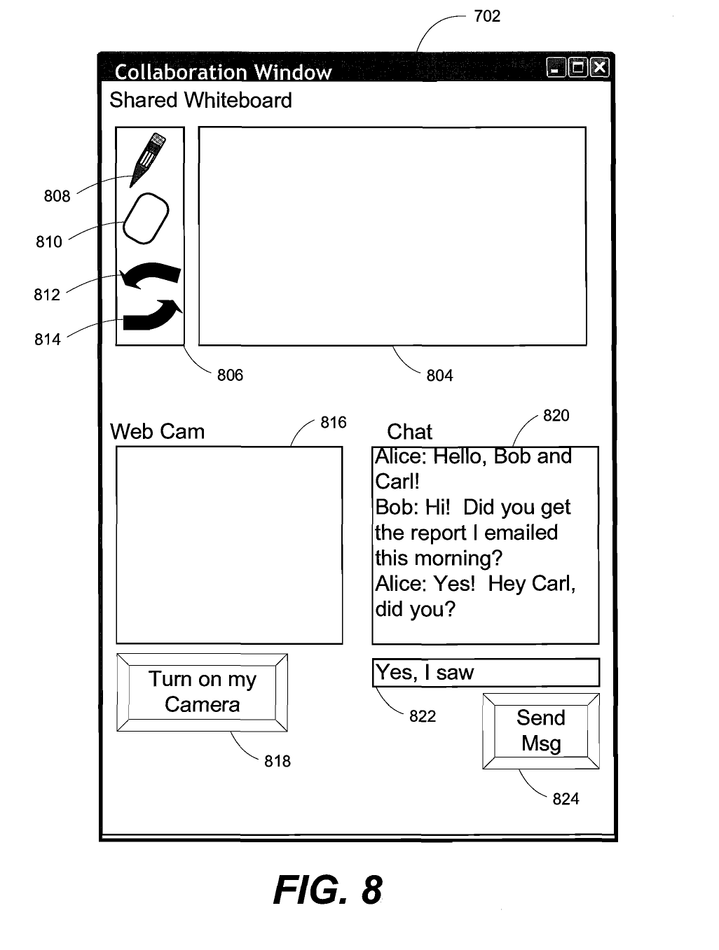

FIG. 8 is a diagrammatic illustration of a collaboration client graphical user interface as it may appear once a collaboration session is established and various widgets or other components provided by the collaboration client are created, have rendered their graphical user interfaces, and are successfully communicating with a collaboration server, according to an example embodiment.

In FIG. 8, the example collaboration client user interface window 702 introduced in FIG. 7 is illustrated as it might appear at a later point in time when rendered by a collaboration client specified by a declarative specification such as, for example, specification 202 of FIG. 2.

It will be appreciated that the collaboration client may include a shared whiteboard including a drawing area 804 and a toolbar 806. The toolbar is illustrated as including a drawing tool 808, an eraser tool 810 and an undo and redo tools 812 and 814 respectively.

In addition, the collaboration client graphical user interface may include a web camera widget including a web camera display window 816 and a camera activation button 818. The camera activation button 818 may be used by the user of the collaboration client to broadcast a stream video to the collaboration server 122 to be propagated to other collaboration clients, such as running on collaboration machines 124 and 126.

The example collaboration client user interface window 702 may also include a chat widget. The chat widget may include a chat dialogue display window 820, a text entry area 822 and a send message button 824. In some embodiments, the chat widget may receive chat text from other users transmitted via the collaboration server 122 and may, in turn (e.g., when the user presses the send button 824) transmit text entered by the user along with user identification information to the collaboration server 122. The entered text may then be propagated to other collaboration machines.

It will be appreciated that a variety of other collaboration client widgets or other tools or affordances may be available including audio and video streams, collaboration participant rosters, polling tools and the like.

### Example Hardware and Computer Systems for Implementing Example Processes

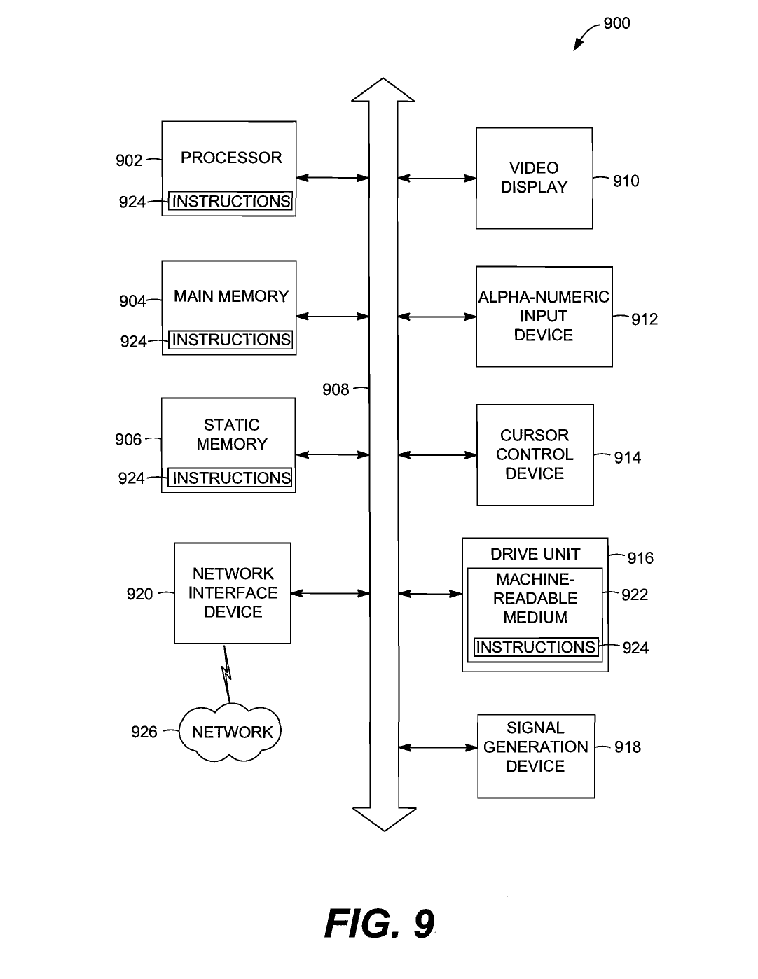

FIG. 9 shows a diagrammatic representation of machine in the example form of a computer system 900 within which a set of instructions, for causing the machine to perform any one or more of the methodologies, methods, processes, or procedures discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 926 via the network interface device 920 utilizing any one of a number of well-known transfer protocols (e.g., HTTP).

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method at a collaboration client, the method comprising:
accessing a first declarative specification element at the collaboration client, the first declarative specification element specifying a collaboration session context and including an identification of a collaboration server to which a collaboration session connection is to be made with the collaboration client;
accessing a second declarative specification element at the collaboration client, the second declarative specification element depending from the first declarative specification element, the second declarative specification element describing a widget that is provided by the collaboration client and uses the collaboration session context;
generating, based on the first declarative specification element, a source code of first instructions at the collaboration client, the source code of the first instructions when executed at the collaboration client instantiates the collaboration session context, the first instructions including multiple asynchronous operations;
generating, based on the second declarative specification element, a source code of second instructions at the collaboration client, the source code of the second instructions when executed at the collaboration client provides functionalities of the widget in the collaboration session context; and
generating sequencing instructions, using a processor, to prevent the second instructions from being executed until the collaboration session context is instantiated.

2. The method of claim 1, wherein the first declarative specification element and the second declarative specification element include markup language tags.

3. The method of claim 1, wherein the second declarative specification element depends from the first declarative specification element by being nested within the first declarative specification element.

4. The method of claim 1, wherein the second declarative specification element depends from the first declarative specification element by being subordinate to the first declarative specification element.

5. The method of claim 1, wherein the first instructions and the second instructions are generated by parsing the first declarative specification element and the second declarative specification element, respectively.

6. (canceled)

7. The method of claim 1, wherein the collaboration session context is used in an execution of the second instructions.

8. The method of claim 1, wherein the second instructions are to create at least one of a video player widget, a shared whiteboard widget, an audio player widget, a multi-user chat widget, a multi-user note-taking widget, a roster list, a file sharing drop box widget, a polling widget, a shared mapping component, a shared presentation component, a shared document review widget, and a shared musical instrument.

9. (canceled)

10. The method of claim 1, wherein the first instructions are operable to create an real time collaboration container.

11. (canceled)

12. The method of claim 1, wherein the asynchronous operations include at least one or more of connecting to a server, authenticating against the server, requesting details about a type of collaboration session, requesting a list of users participating in a collaboration session, requesting a set of audio sessions, requesting a set of video sessions, requesting a set of published files, or receiving a response from the server.

13. A collaboration client comprising:
a data access module to access a first declarative specification element at the collaboration client, the first declarative specification element specifying a collaboration session context and to access a second declarative specification element at the collaboration client, the second declarative specification element depending from the first declarative specification element, the first declarative specification element including an identification of a collaboration server to which a collaboration session connection is to be made, the second declarative specification element describing a widget that uses the collaboration session context; and
a parsing module, implemented by a processor, to generate, based on the first declarative specification element, a source code of first instructions at the collaboration client, the source code of the first instructions when executed at the collocation client instantiates the collaboration session context, to generate, based on the second declarative specification element, a source code of second instructions at the collaboration client, the source code of the second instructions when executed at the collaboration client provides functionalities of the widget in the collaboration context, and to generate sequencing instructions to prevent the second instructions from being executed until the collaboration session context is instantiated.

14. The collaboration client of claim 13, wherein the first declarative specification element and the second declarative specification element include markup language tags.

15. The collaboration client of claim 13, wherein the second declarative specification element depends from the first declarative specification element by being nested within the first declarative specification element.

16. The collaboration client of claim 13, wherein the second declarative specification element depends from the first declarative specification element by being subordinate to the first declarative specification element.

17. The collaboration client of claim 13, wherein the first instructions and the second instructions are generated by parsing the first declarative specification element and the second declarative specification element, respectively.

18. (canceled)

19. The collaboration client of claim 13, wherein the collaboration session context is used in an execution of the second instructions.

20. (canceled)

21. The collaboration client of claim 13, wherein the first instructions are operable to create an real time collaboration container.

22. The collaboration client of claim 13, wherein the first instructions include asynchronous operations.

23. The collaboration client of claim 22, wherein the asynchronous operations include at least one or more of connecting to a server, authenticating against the server, requesting details about a type of collaboration session, requesting a list of users participating in a collaboration session, requesting a set of audio sessions, requesting a set of video sessions, requesting a set of published files, or receiving a response from the server.

24. (canceled)

25. A non-transitory machine-readable storage medium comprising instructions, which when implemented by one or more processors perform the following operations:
accessing a first declarative specification element at the collaboration client, the first declarative specification element specifying a collaboration session context and including an identification of a collaboration server to which a collaboration session connection is to be made;
accessing a second declarative specification element at the collaboration client, the second declarative specification element depending from the first declarative specification element, the second declarative specification element describing at least one of a widget and a component that uses the collaboration session context, the at least one of the widget and the component facilitating interaction between a collaboration client user and another collaboration participant;
generating, based on the first declarative specification element, a source code of first instructions at the collaboration client, the source code of the first instructions when executed at the collaboration client instantiates the collaboration session context;
generating, based on the second declarative specification element, a source code of second instructions at the collaboration client, the source code of the second instructions when executed at the collaboration client provides functionalities of the at least one of the widget and the component in the collaboration session context; and
generating sequencing instructions to prevent the second instructions from being executed until the collaboration session context is instantiated.
